(19) United States
(12) Patent Application Publication
(10) Pub. No.: US 2004/0164872 A1
(43) Pub. Date: Aug. 26, 2004

(54) Battery free audio door bell

(76) Inventors: Ching-Huan Chiu, Taichung (TW); Tao-Hsi Chi, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/370,775

(22) Filed: Feb. 24, 2003

(51) Int. Cl. G08B 25/08

(52) U.S. Cl. 340/692

(57) ABSTRACT

A battery free door bell includes a power supply unit connected to two limited-voltage wave-filtering circuit units for providing power to interior circuit and exterior circuit. The interior circuit has a steady voltage unit and a first amplifying circuit unit so as to provide a signal to a music IC unit. A second amplifying circuit unit is connected to a speaker. The exterior circuit has a switch unit, a delay circuit and a third amplifying circuit unit. A storage circuit unit is connected to the delay circuit unit. The third amplifying circuit unit continuously activates the music IC unit.

### FIELD OF THE INVENTION

The present invention relates to an IC music door bell that requires no batteries.

### BACKGROUND OF THE INVENTION

A conventional door bell that may generate music generally uses direct electric current so that it needs proper parts to provide electricity when the button is pushed. One of the music door bells is equipped with two electric capacitors which are connected in parallel so as to provide delay electric power. Nevertheless, the parallel electric capacitors consumes a lot of energy and if the door bell is in ready-for-use status for 24 hours, then the electric power consumes the 24 hour period. Another type of door bell can be powered by AC or DC. Nevertheless, this type of circuit cannot provide steady electric voltage so that it cannot generate high quality of sound. If the music door bell is powered by batteries, the batteries have to be replaced frequently because the music IC consumes a lot of electric power.

The present invention intends to provide a music door bell that is powered by alternative electric current and a delay circuit and a steady voltage device are used to provide steady electric power to drive the music IC.

### SUMMARY OF THE INVENTION

In accordance with one aspect of the present invention, there is provided a battery free door bell which comprises a power supply unit and two limited-voltage wave-filtering circuit units are respectively connected to the power supply unit so as to provide electric power to an interior circuit and exterior circuit. The interior circuit has a steady voltage unit and a first amplifying circuit unit and provides a signal to a music IC unit. A second amplifying circuit unit is connected to a speaker. The exterior circuit has a switch unit, a delay circuit and a third amplifying circuit unit. A storage circuit unit is connected to the delay circuit unit. The third amplifying circuit unit continuously activates the music IC unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a circuit block diagram of the door bell of the present invention, and

FIG. 2 shows a circuit block diagram of another embodiment of the door bell of the present invention.

### DETAILED DESCRIPTION OF THE PREFERRED EMBODIMENT

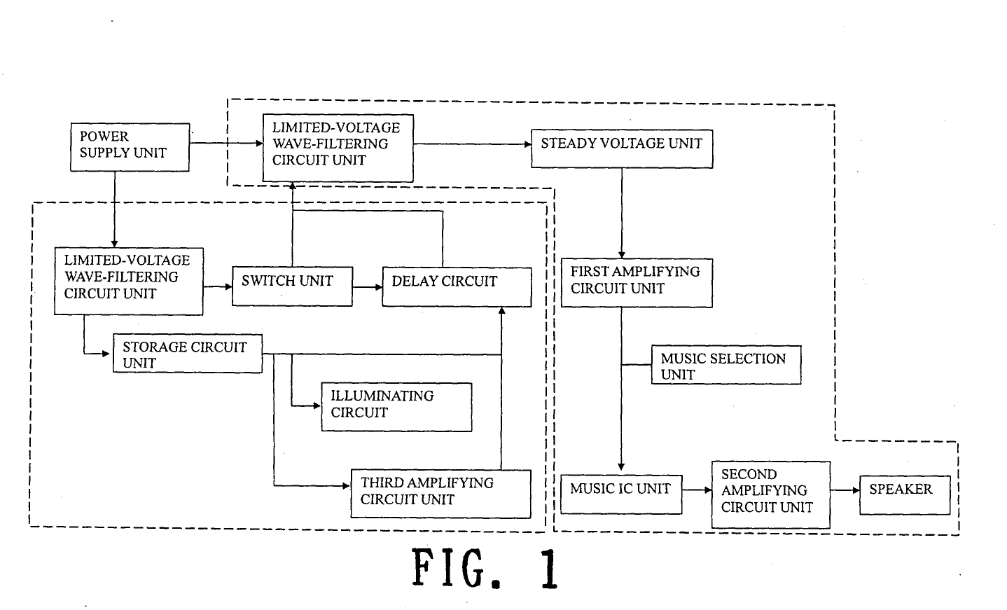

Referring to FIG. 1, the battery free door bell of the present invention comprises a power supply unit 10 so as to provide alternative electric current to the whole circuit, and two limited-voltage wave-filtering circuit units 20, 21 are respectively connected to the power supply unit 10 so as to respectively provide electric power to an interior circuit and exterior circuit.

The interior circuit has a steady voltage unit 30 for providing a 5V voltage and is connected to a first amplifying circuit unit 40 so as to provide a signal to a music IC unit 50 which then sends a signal to a second amplifying circuit unit 60 which is connected to a speaker 70 so that people in the interior of a house can hear the sound.

The exterior circuit has a switch unit 80, a delay circuit 90 and a third amplifying circuit unit 61. The switch unit 80 controls the whole circuit of the bell and is a normal-open switch. An open circuit is connected between the delay circuit unit 90 and the music IC unit 50. A relay may be used to delay the action when the open circuit is closed. A storage circuit unit 100 is connected to the delay circuit unit 90 which has a 3.3 μf capacitor so as to provide steady voltage. The third amplifying circuit unit 61 makes the current that is provided by the delay circuit to be more steady so as to continuously activating the music IC unit.

When the switch unit 80 is pushed, the interior circuit and exterior circuit are electrically connected and after the switch unit 80 is released, the storage circuit unit 100 provides a current with a lower voltage to the delay circuit 90, and the music IC is continuously activated. The third amplifying circuit unit 61 provides steady current to the delay circuit 90 and the music IC 50 sends pre-set music via the speaker 70.

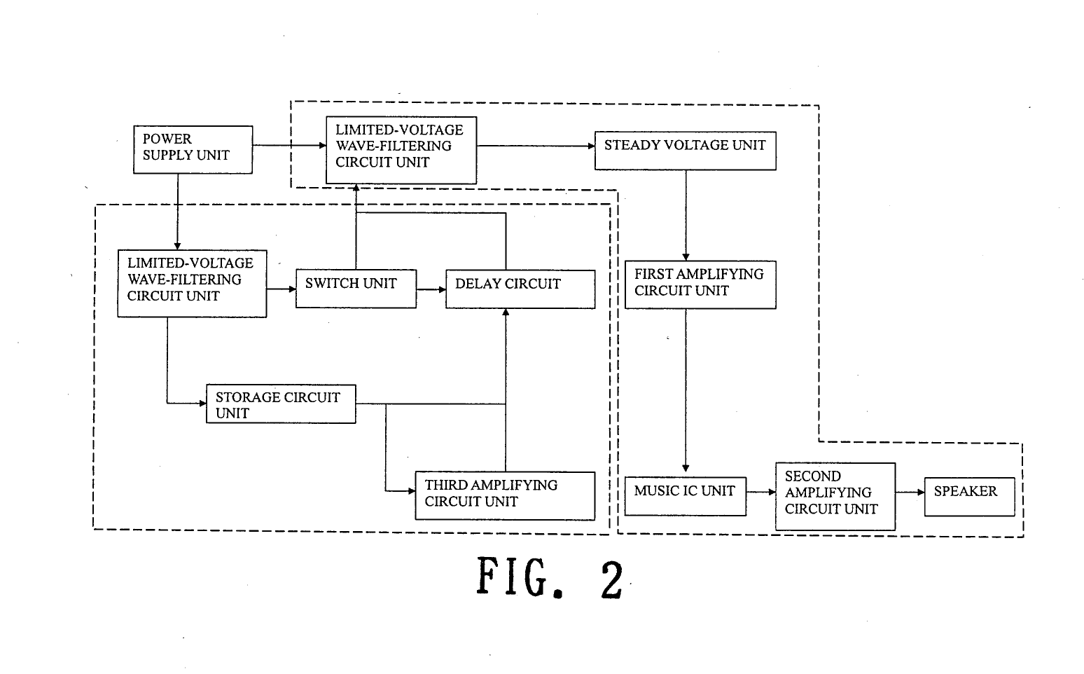

As shown in FIG. 2, an illuminating circuit 110 or an audio means is connected between the delay circuit 90 and the storage circuit unit 100 so that the user knows that the switch circuit 80 is successfully operated. A music optional unit may also be connected between the music IC unit 50 and the first amplifying circuit unit 40 so as to choose a desired music when the switch circuit 80 is activated.

While we have shown and described the embodiment in accordance with the present invention, it should be clear to those skilled in the art that further embodiments may be made without departing from the scope of the present invention.

What is claimed is:

1. A battery free door bell comprising:
a power supply unit;
two limited-voltage wave-filtering circuit units respectively connected to the power supply unit and providing electric power to an interior circuit and exterior circuit;
the interior circuit having a steady voltage unit, a first amplifying circuit unit and providing a signal to a music IC unit, a second amplifying circuit unit connected to a speaker;
the exterior circuit having a switch unit, a delay circuit and a third amplifying circuit unit, and
a storage circuit unit connected to the delay circuit unit, the third amplifying circuit unit continuously activating the music IC unit.

2. The battery free door bell as claimed in claim 1, wherein an illuminating circuit is connected between the delay circuit and the storage circuit unit.
